(19) United States
(12) Patent Application Publication
(10) Pub. No.: US 2024/0001744 A1
(43) Pub. Date: Jan. 4, 2024

(54) LIFTING ROOF FOR A VEHICLE, IN PARTICULAR FOR A PANEL VAN, A CAMPERVAN OR A CARAVAN, AND METHOD FOR PRODUCING SAME

(71) Applicant: C.F. Maier GmbH & Co. KG, Königsbronn (DE)

(72) Inventor: Erich Sauter, Kaufbeuren (DE)

(21) Appl. No.: 18/368,757

(22) Filed: Sep. 15, 2023

Related U.S. Application Data
(63) Continuation of application No. PCT/EP2022/055172, filed on Mar. 1, 2022.

(30) Foreign Application Priority Data
Mar. 18, 2021 (DE) 10 2021 106 725.1

(51) Int. Cl. B60J 7/16

(52) U.S. Cl. CPC B60J 7/1642; B60J 7/165

(57) ABSTRACT

A lifting roof for a vehicle having an outer shell and an inner shell which are adhesively bonded to one another. Production is carried out by separately producing the outer shell and the inner shell from a material comprising plastic, the shells being positioned in relation to one another and adhesively bonded to one another, wherein metal parts are also concomitantly introduced at least for receiving hinges and closures.

### CROSS-REFERENCE TO RELATED APPLICATIONS

This is a Continuation application of International patent application PCT/EP2022/055172, filed Mar. 1, 2022, which claims the priority of German patent application DE 10 2021 106 725.1, filed Mar. 18, 2021. Both applications, PCT/EP2022/055172 and DE 10 2021 106 725.1, are herewith incorporated by reference in their entireties.

### FIELD

The present disclosure relates to a vehicle roof in the form of a lifting roof, in particular for a panel van, a campervan or a caravan.

### BACKGROUND

Lifting roofs intended to be retrofitted in a panel van, for instance, already exist. Lifting roofs of this kind are always attached by means of hinges to a peripheral installation frame, which is attached to an opening, created by cutting open the roof, during retrofitting. It is understood that at least one closure must also be provided in order to allow the lifting roof to be securely closed and fastened to the installation frame.

Lifting roofs of this kind are typically produced in a sandwich design in order to achieve high stability in combination with good insulation properties. However, the assembly is relatively complex and expensive. Moreover, constructions of this kind are not very flexible and cannot be easily recycled.

### SUMMARY

It is an object to provide an improved lifting roof for a vehicle, which lifting roof can be produced as simply and as cost-effectively as possible, makes simplified recycling possible, and enables the greatest possible variability during production. The intention is also to specify a suitable method for producing such a roof.

According to an aspect, a lifting roof for a vehicle is presented, in particular for a panel van, a campervan or a caravan, having an outer shell and an inner shell, which are adhesively bonded to one another, wherein the outer shell and the inner shell are made of a material comprising plastic, wherein the lifting roof further comprises metal parts that are configured to receive functional elements, said metal parts comprising at least one receptacle made of metal, said at least one receptacle being configured to attach hinges.

According to a further aspect, a method for producing a lifting roof for a vehicle is presented, wherein an outer shell and an inner shell are produced from a material comprising plastic, said shells being positioned in relation to one another and adhesively bonded to one another, and wherein metal parts are provided at least for receiving hinges.

The fact that the vehicle roof is in this case produced by adhesively bonding an outer shell and an inner shell together results in significantly increased flexibility in terms of the design of the roof. For example, it is possible to adapt the properties of the roof to various requirements by changing the design of the inner roof while allowing the contour of the outer roof to remain unchanged. The provision of at least one receptacle made of metal for attaching hinges therefore makes it possible to install the lifting roof directly on the vehicle.

Producing a vehicle roof by adhesively bonding an outer shell and an inner shell is generally known (cf. DE 102013107203 A1, DE 10141243 A1). However, the present disclosure is not suggested by these documents, since they do not relate to a lifting roof in which specific metal parts are provided for attaching hinges, for instance.

The roof can also be recycled much more easily if the outer roof and inner roof are separated from one another again.

Moreover, the roof is more lightweight than a conventionally produced roof, which is produced in a sandwich design.

Furthermore, at least one closure made of metal can be provided for securing the vehicle roof to an installation frame.

The fact that the necessary metal parts for attaching and securing the roof are directly concomitantly installed results in a simplified and cost-effective construction.

According to a further refinement, the inner shell has a plurality of elements that project plastically towards the inside. The plurality of elements may have at least two longitudinal struts running in the longitudinal direction of the roof and at least two transverse struts running in the transverse direction of the roof.

This increases the strength of the roof. At the same time, the longitudinal and transverse struts can create cavities, which can be used for fittings.

According to a further refinement, at least some of the elements are configured in the form of reinforcing elements.

This allows the strength of the roof to be increased with the weight being reduced.

According to a further refinement, at least one cavity is formed between the outer shell and the inner shell, it being possible to use said cavity for fittings, in particular for cables, ventilation and air conditioning, lighting, loudspeakers, roof linings, electrical connectors, glass roofs, etc.

In this way, the novel roof construction allows a significantly improved functionality of the roof to be achieved in a simple manner.

According to a further refinement, photovoltaic elements are provided on the outside of the outer shell, it being possible to couple said photovoltaic elements to rechargeable batteries, which are received in a cavity formed between the outer shell and inner shell.

This allows a self-contained power supply for the vehicle roof to be achieved.

According to a further refinement, the inner shell peripherally has a plurality of tabs, which are configured to be adhesively bonded to the outer shell. In particular, the form of the tabs is adapted to the contour of the outer shell such that a highly secure and permanent adhesive bond between the outer shell and the inner shell is ensured in the region of the tabs, even with just a thin layer of adhesive.

This results in a favourable adhesive bond and therefore good adhesion between the inner shell and outer shell. Moreover, recycling is made easier, since subsequent separation of the outer shell and inner shell is made easier in the areas predefined for this purpose.

In the production method according to the disclosure for producing a lifting roof, during the production of the outer shell or inner shell, the metal parts may be integrally bonded to at least one of the shells, in particular are foamed in place or laminated in place.

This guarantees particularly good adhesion between the metal parts to be introduced and the outer shell and/or the inner shell. For this purpose, it is only needed to fix the metal parts in a suitable manner before the foaming or lamination process is carried out.

According to a further refinement, the metal parts are adhesively bonded to the outer shell and/or the inner shell.

This allows individual metal parts to be integrated even after the inner shell or outer shell has been produced.

In a further refinement, at least one cavity is created between the outer shell and inner shell, it being possible to use said cavity for fittings, in particular for cables, ventilation and air conditioning, loudspeakers, lighting, roof linings, electrical connectors, glass roofs, etc.

This allows various fittings to be integrated into the roof in a simple manner.

It is understood that the features mentioned above and the features yet to be discussed below may be used not only in the respectively specified combination, but also in other combinations or individually without departing from the spirit and scope of the present disclosure.

### DRAWINGS

Further features and advantages of the disclosure will become apparent from the description hereinafter of preferred exemplary embodiments with reference to the drawing, in which:

FIG. 1 shows a perspective illustration from the outside of a lifting roof, which is placed on an associated installation frame;

FIG. 2 shows the lifting roof according to FIG. 1 as seen obliquely from below;

FIG. 3 shows a perpendicular view from below of the lifting roof according to FIG. 2;

FIG. 4 shows a perspective illustration of the inner shell of the lifting roof as seen from the underside without the outer shell;

FIG. 5 shows the inner shell according to FIG. 4, but as seen from the top side;

FIG. 6 shows a longitudinal section through the lifting roof according to FIG. 1;

FIG. 7 shows a cross section through the lifting roof according to FIG. 1; and

FIG. 8 shows, by way of example, a vehicle in the form of a panel van, on the roof of which a lifting roof has been installed.

### DETAILED DESCRIPTION

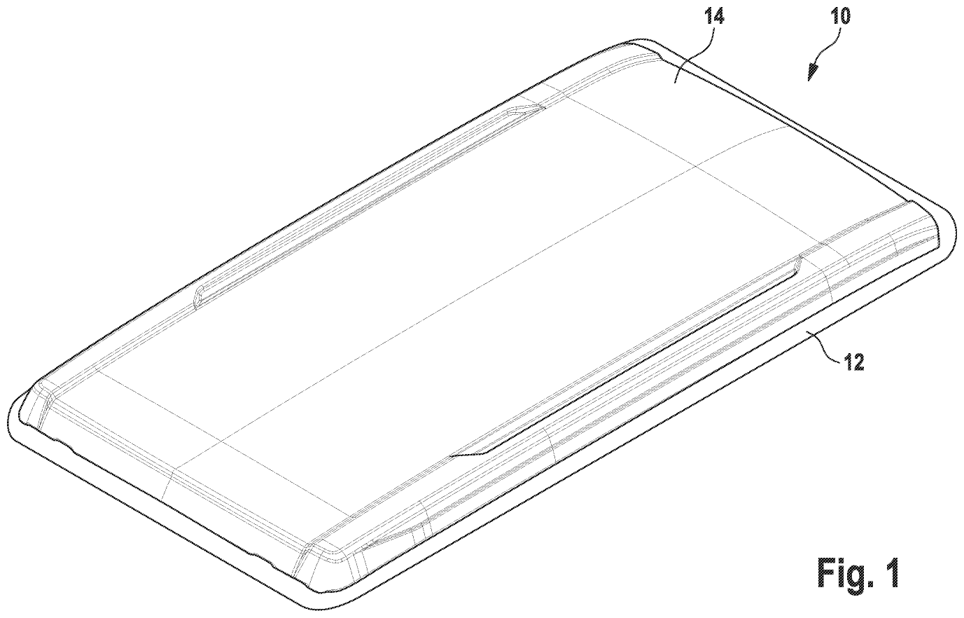

FIG. 1 shows a perspective illustration of a lifting roof, which is denoted overall by the numeral 10. The entire lifting roof 1 is illustrated as resting on an installation frame 12 (sometimes also known as a platform).

The installation frame 12 is used to retrofit a vehicle, for example a panel van, with the lifting roof 10. For this purpose, a suitably sized recess is cut out of the roof and the installation frame 12 is attached thereto. In this case, the lifting roof 10 can already be configured in the form of a complete installation unit together with the installation frame 12 in order to make particularly simple mounting of the lifting roof on a particular vehicle possible. In general, the lifting roof 10 can be folded open and has a reclining area, which can be opened out.

In this regard, FIG. 8 illustrates, by way of example, a vehicle 78 in the form of a panel van. The roof has been cut open and an installation frame 12 installed. A lifting roof 10, which is illustrated in folded-open form in FIG. 8, is attached to said installation frame. It is held, at one end, on the installation frame 12 by scissor hinges 80. A fabric bellows or substructure 82, which is held on the lifting roof 10 and contains a reclining area with a mattress, can also be seen in FIG. 8.

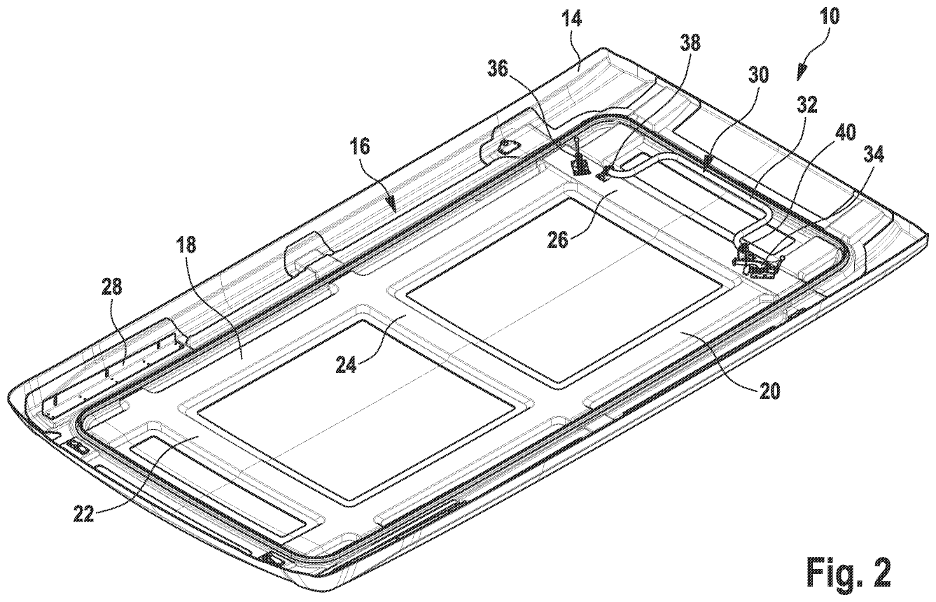

The lifting roof 10 has a two-shell assembly, having an outer shell 14, which can be seen in FIG. 1, and having an inner shell 16, which can be seen in FIG. 2. The outer shell 14 and the inner shell 16 are adhesively bonded together. The outer shell 14 and the inner shell 16 are made of plastic, for example of polypropylene. Additionally, a number of metal parts, which are required for the operation of the lifting roof 10, are received on the lifting roof 10.

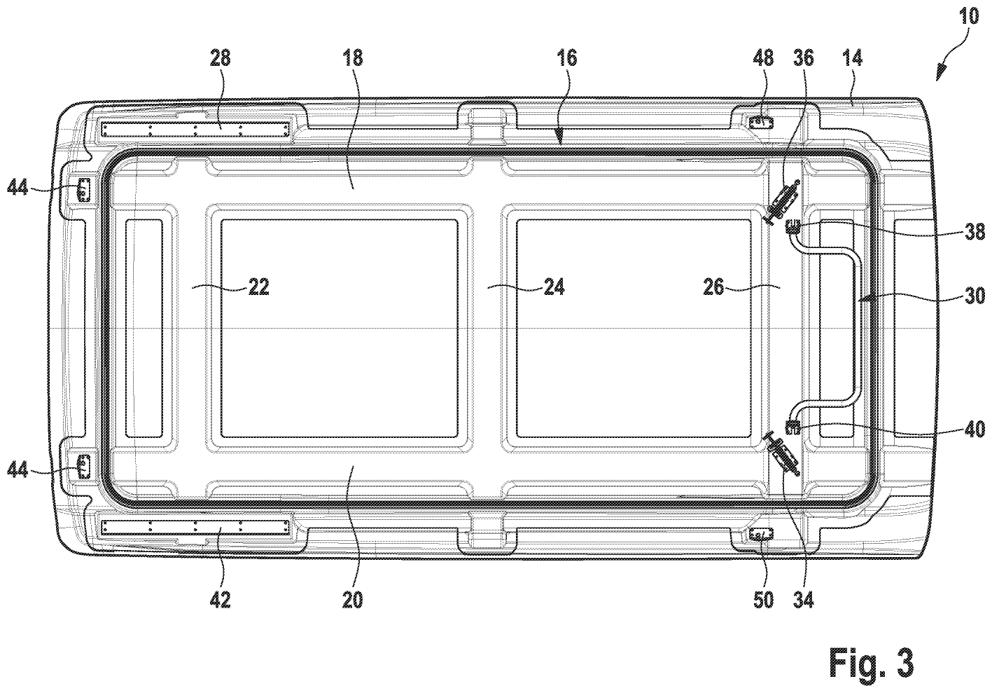

By way of example, two hinge receptacles 28, 42, which are used to attach scissor hinges 80 (cf. FIG. 8) that are connected to the installation frame 12, are received at one end of the inner shell 16 in FIG. 2 and in FIG. 3. Scissor hinges 80 of this kind make it possible to fold the roof open outwards. Additionally, gas pressure springs, which are likewise articulated to metal installation parts, are generally provided.

It is understood that the lifting roof 10, when it is in its folded-shut position, must be securely fixed to the installation frame 12 for travelling.

For this purpose, by way of example, a closure 30 in the form of a pull handle on the side of the lifting roof 10 opposite the two hinge receptacles 28, 42 can be seen in FIGS. 2 to 4. The closure 30 has a closure lever 32 in the form of a holding bar, which is pivotably mounted on two receptacles 38, 40 and one end of which is coupled to a lock 34. Additionally, another lock 36 is provided at the other end.

In this way, the lifting roof 10, in its closed position, can be securely attached to the installation frame 12 by means of the closure 30.

During the production of the lifting roof 10, all of the necessary installation parts made of metal, which are necessary for the subsequent assembly of the lifting roof 10, are concomitantly integrated.

For this purpose, by way of example, four fixtures 44, 46, 48, 50 are provided, in addition to the hinge receptacles 28, 42, in the figures, in each case in the corner region. These fixtures are used, for example, for receiving ball-headed joints or gas pressure springs (not illustrated) or a sleeping apparatus with a mattress, which can be opened out (not illustrated). For example, a roof lining could also be attached thereto.

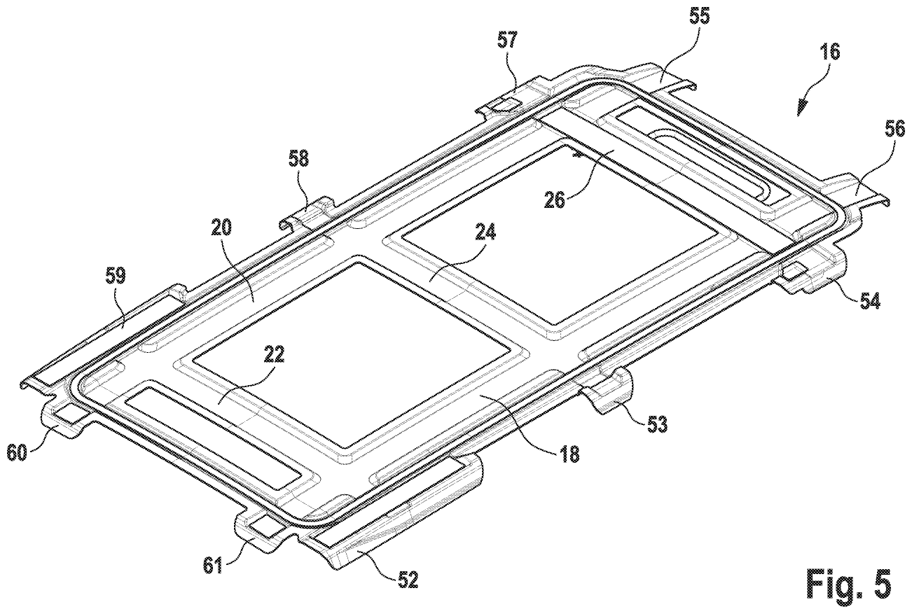

As can be seen from FIGS. 2 to 5, a total of two longitudinal struts 18 and three transverse struts 22, 24, 26 are formed between the outer shell 14 and inner shell 16. These struts that project plastically towards the inside of the roof result in a significant increase in strength. Also, the cavities formed thereby can be used for fittings. For example, in these cavities, cables can be laid, ventilation and air conditioning elements can be introduced, loudspeakers can be attached, lighting elements, for example LEDs or light strips, can be attached, a roof lining can be attached, electrical connectors, for example USB connectors etc. A glass roof can also be received in the intermediate spaces between the longitudinal struts 18, 20 and the transverse struts 22, 24, 26.

Cavities, which are formed between the outer shell 14 and inner shell 16, can be used for numerous installation parts.

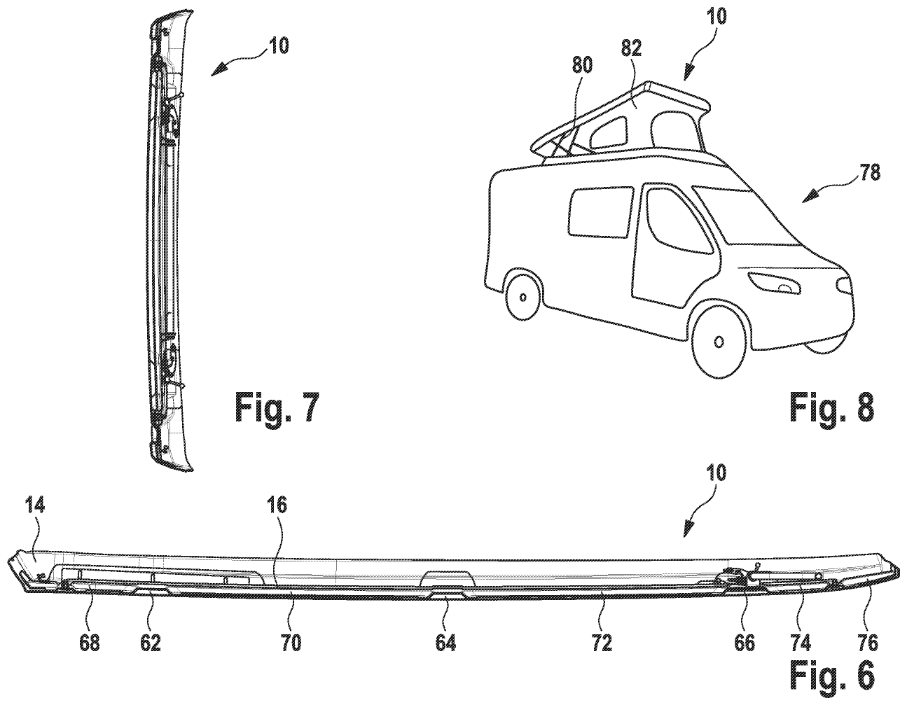

The sectional illustration according to FIG. 6 illustrates a number of cavities 62, 64, 66, 68, 70, 72, 74, 76 by way of example.

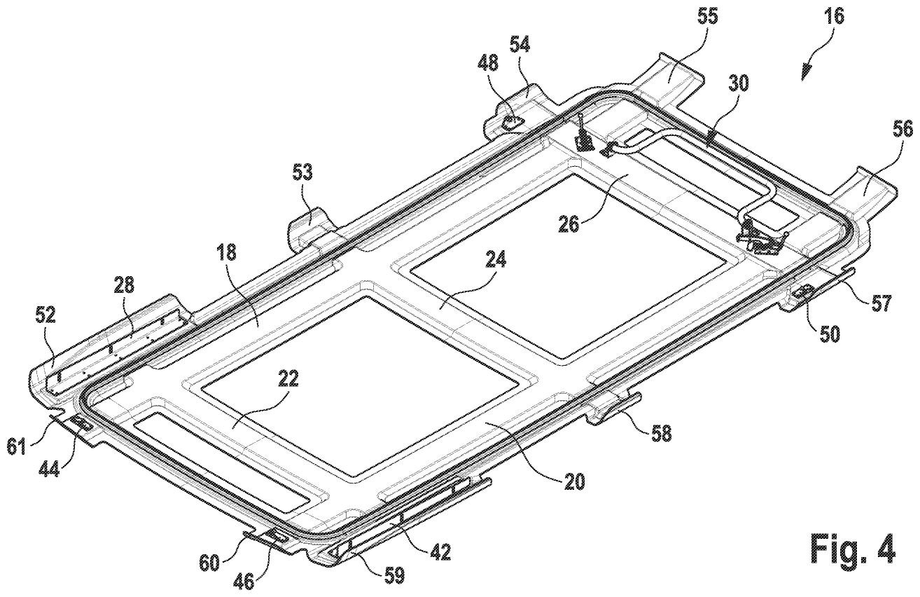

From the view from below of the inner shell 16 according to FIG. 4, it can also be seen that the periphery of the inner shell 16 is provided with a plurality of tabs, which are used for resting in a planar manner on the outer shell 14, as a result of which an adhesive connection can be created at selected locations. These peripheral tabs are denoted by 52, 53, 54, 55, 56, 57, 58, 59, 60, 61 in FIG. 4.

The fact that the adhesive connections are limited, in particular to the regions predefined by the tabs 52 to 60, and optionally the regions of the longitudinal struts 18, 20 and transverse struts 22, 24, 26, makes recycling easier since, in the event of reprocessing, the inner shell 16 and outer shell 14 can be separated from one another specifically at these points.

During the production of the inner shell 16 or outer shell 14, the necessary metal parts and fixtures may be directly fixed either to the outer shell or the inner shell by being foamed in place or laminated. For this purpose, the necessary metal parts may be attached to the inner shell. By contrast, the outer shell 16 can then have a consistent form for a particular type of vehicle, while different metal parts are concomitantly foamed in place or laminated in place on the inner shell 16 depending on the embodiment.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A lifting roof for a vehicle, having an outer shell and an inner shell, which are adhesively bonded to one another, wherein the outer shell and the inner shell are made of a material comprising plastic, wherein the lifting roof further comprises metal parts that are configured to receive functional elements, the metal parts comprising at least one receptacle made of metal, the at least one receptacle being configured to attach hinges.

2. The lifting roof according to claim 1, wherein the outer shell and the inner shell consist of plastic.

3. The lifting roof according to claim 1, further comprising at least one closure made of metal that is configured to secure the lifting roof to an installation frame.

4. The lifting roof according to claim 1, wherein the inner shell has a plurality of elements that project plastically inwards.

5. The lifting roof according to claim 4, wherein the plurality of elements have at least two longitudinal struts running in a longitudinal direction of the roof and at least two transverse struts running in a transverse direction of the roof.

6. The lifting roof according to claim 4, wherein at least some of the elements are configured as reinforcing elements.

7. The lifting roof according to claim 1, wherein at least one cavity is formed between the outer shell and the inner shell, the cavity being usable for fittings.

8. The lifting roof according to claim 7, wherein the fittings are at least one of cables, ventilation and air conditioning, lighting, roof linings, electrical connectors, or glass roofs.

9. The lifting roof according to claim 1, wherein the inner shell peripherally comprises a plurality of tabs, which are configured to be adhesively bonded to the outer shell.

10. The lifting roof according to claim 1, wherein the metal parts are foamed or laminated to at least one of the inner shell or the outer shell.

11. The lifting roof according to claim 1, wherein the vehicle is a panel van, a campervan, or a caravan.

12. A method for producing a lifting roof for a vehicle, wherein an outer shell and an inner shell are produced from a material comprising plastic, the shells being positioned in relation to one another and adhesively bonded to one another, and wherein metal parts are provided at least for receiving hinges.

13. The method of claim 12, wherein the outer shell and the inner shell are produced from plastic.

14. The method of claim 12, wherein the metal parts are introduced for receiving the hinges and closures.

15. The method of claim 12, wherein the inner shell has a plurality of elements that project plastically inwards.

16. The method according to claim 12, wherein, during the production of the outer shell or the inner shell, the metal parts are integrally bonded to at least one of the shells.

17. The method according to claim 12, wherein, during the production of the outer shell or inner shell, the metal parts are foamed or laminated to at least one of the shells.

18. The method according to claim 12, wherein the metal parts are adhesively bonded to the outer shell and/or the inner shell.

19. The method according to claim 12, wherein at least one cavity is created between the outer shell and inner shell, the cavity being usable for fittings.

20. The method of claim 19, wherein the fittings are at least one of cables, ventilation and air conditioning, lighting, roof linings, electrical connectors, or glass roofs.
